(19) United States
(12) Patent Application Publication
(10) Pub. No.: US 2014/0312679 A1
(43) Pub. Date: Oct. 23, 2014

(54) CUTTING CHAIN

(71) Applicants: William Stephen Clapham, Barnsley (GB); Philip Nigel Moore, Doncaster (GB)

(72) Inventors: William Stephen Clapham, Barnsley (GB); Philip Nigel Moore, Doncaster (GB)

(73) Assignee: ESCO Hydra (UK) Limited, South Youkshire (GB)

(21) Appl. No.: 14/071,627

(22) PCT Filed: May 3, 2012
(86) PCT No.: PCT/US12/36286

§ 371 Date: Jun. 2, 2014

(30) Foreign Application Priority Data
May 4, 2011 (GB) 1107334.3

(51) Int. Cl. E02F 5/06; F16G 15/12

(52) U.S. Cl. CPC E02F 5/06; F16G 15/12
USPC 299/82.1; 59/84; 59/85

(57) ABSTRACT

A chain link (1) of steel has two spaced-apart transverse apertures (2) to receive portions of leading and trailing pivot pins (4) and, on an upper surface, a seat (6, 7) to receive a welded-in pick box (8), the link (1), at one side at least, being provided with at least one pad (14) of a material of higher wear resistance than the steel of the link (1). The invention also includes a steel pivot pin (4) for use in connecting together, in an articulated manner, steel links (1) of mineral cutter/removal chain, at least one end of the pin (4) being provided with a wear pad (16). The invention also includes a mineral cutting/removal chain for use with an inclined jib, constructed from an odd number of links (1) articulated on pins (4).

### FIELD OF THE INVENTION

This invention relates in one aspect to a link for forming part of a cutting chain, in another aspect to a pivot pin for connecting such links, and in yet another aspect to a cutting chain assembled from a plurality of such links and pivot pins.

### BACKGROUND OF THE INVENTION

Pick carrying cutting chains have been used extensively in the mining of minerals such as coal and potash, either as primary cutting elements, or as secondary cutting elements e.g. covering non-cutting portions of the boom of a continuous mining machine.

Single link chains were employed decades ago for cutting a kerf at the foot of a coal seam, whilst multi-link chains employing e.g. three links are employed on modern mining machines.

Some links are provided with a pick box (also known as a tool holder) adapted to releasably retain the shank of a carbide tipped, mineral cutter pick requiring regular replacement e.g. daily or at every shift, and wear on the links is not considered a major problem as drive sprockets of the chain are rotatable about horizontal, or generally horizontal, axes.

In another field of activity however—the provision of a trench on the seabed to house an oil etc pipeline—multiple cutter jibs carried by a self-propelled cutting machine are proposed to be employed at inclined angles, with the drive sprockets typically at 45°, or thereabouts to the horizontal, to cut a “V”-shaped trench, as the cutting machine advances. This inclination of say 30°-70° to the horizontal transfers the weight of the “upper” links of the chains to the lower links, and if say a nine-link chain is involved, a considerable weight transfer takes place, such that the lower links, which, in use, are in sliding contact with the jib, are subject to premature wear.

### OBJECT OF THE INVENTION

A basic object of the invention is the provision of an improved chain link, pivot pin and cutting chain particularly for use with inclined jibs.

### SUMMARY OF A FIRST ASPECT OF THE INVENTION

According to a first aspect of the invention, there is provided a chain link of steel having two spaced-apart transverse apertures to receive portions of leading and trailing pivot pins and, on an upper surface, a seat to receive a welded-on pick box, characterised in that the link, at one side at least, is provided with at least one pad of a material of higher wear resistance than the steel of the link.

### SUMMARY OF A SECOND ASPECT OF THE INVENTION

According to a second aspect of the invention, of independent significance, there is provided a steel pivot pin for use in connecting together, in an articulated manner, steel links of mineral cutter/removal chain, characterised in that at least one end of the pin is provided with a pad of a material of higher wear resistance than the steel of the pin.

### SUMMARY OF A THIRD ASPECT OF THE INVENTION

According to a third aspect of the invention, of independent significance there is provided a mineral cutting/removal chain for use with an inclined jib, constructed from an odd number of links in accordance with the first aspect.

### SUMMARY OF A FOURTH ASPECT OF THE INVENTION

According to a fourth aspect of the invention, of independent significance, there is provided a mineral cutting/removal chain for use with an inclined jib, constructed from an odd number of links in accordance with the first aspect, articulated together by a plurality of pins in accordance with the second aspect.

### ADVANTAGES OF THE INVENTION

When installed on an inclined jib, the weight transfer from upper links of the chain on to lower or outermost links of the chain would tend to cause excessive wear of the row of links adjacent the lower side of the jib, by those lower or outermost links rubbing along the lower side of the jib, which lower side is typically provided by a steel plate. Clearly, this would result in a need for early replacement of that row of links, particularly if as is usually the case, abrasive grit etc penetrates between the side plate of the jib and the adjacent face of the lower or outermost links, with resultant down-time, which would be extended by the time required to raise a cutting machine from the seabed, and return it to the seabed after chain repairs, and the introduction of at least one wear pad on the links and/or the pins is aimed at obviating premature failure.

### PREFERRED OR OPTIONAL FEATURES OF THE FIRST ASPECT OF THE INVENTION

A wear pad is provided only at, or in, one side of each link.

Intermediate the apertures for the pivot pins, a blind hole is drilled into the side of the link, to receive a wear pad.

The wear pad is of solid carbide.

The wear pad is of tungsten carbide.

The wear pad is of carbide in a matrix.

The wear pad is secured in position by adhesive, avoiding the need for brazing etc with possible adverse effects on the grain structure of the link.

Along a lower edge of the link, at the wear pad side only, with a projecting rib is provided for chain engagement/guidance purposes.

The links are heat treated steel forgings, with the wear pad glued into place after welding on of the pick box.

### PREFERRED OR OPTIONAL FEATURES OF THE SECOND ASPECT OF THE INVENTION

A wear pad is provided at one end only of each pivot pin.

A wear pad is provided at each end of each pivot pin.

The provision of pivot pins with a wear pad results in three spaced-apart, wear pads being presented at one side of each link.

A blind hole is drilled into at least one end of each pivot pin into which hole(s) a wear pad is inserted.

The pivot pin wear pad is/are secured by adhesive.

The pivot pin wear pad is/are of solid carbide.

The pivot pin wear pad is/are of tungsten carbide.

The pivot pin wear pad is/are of carbide in a matrix.

### PREFERRED OR OPTIONAL FEATURES OF THE THIRD AND FOURTH ASPECTS OF THE INVENTION

The chain is constructed with an odd number of links e.g. three, five, seven or nine links etc, the outer sides of outermost links being provided with at least one wear pad.

### BRIEF DESCRIPTION OF THE DRAWINGS

FIG. 1 is a perspective view of a link in accordance with the first aspect of the invention;

FIG. 2 is a side elevation of the link of FIG. 1;

FIG. 3 is a top plan of the link of FIG. 1;

FIG. 4 is a section on the line IV-IV if FIG. 2;

FIG. 5 is a section on the line V-V of FIG. 2;

FIG. 6 is a section on the line VI-VI of FIG. 3;

FIG. 7 is a side elevation of a pin in accordance with the second aspect of the invention;

FIG. 8 is an enlarged view of one end of the pin of FIG. 7;

FIG. 9 is a section on the line IX-IX of FIG. 8.

FIG. 10 is a top plan view of a portion of a three-link chain in accordance with the third and fourth aspects of the invention;

FIG. 11 is an end elevation of FIG. 10.

FIG. 12 is a top plan view of a portion of a nine-link chain in accordance with the third and fourth aspects of the invention; and

FIG. 13 is an end elevation of FIG. 12.

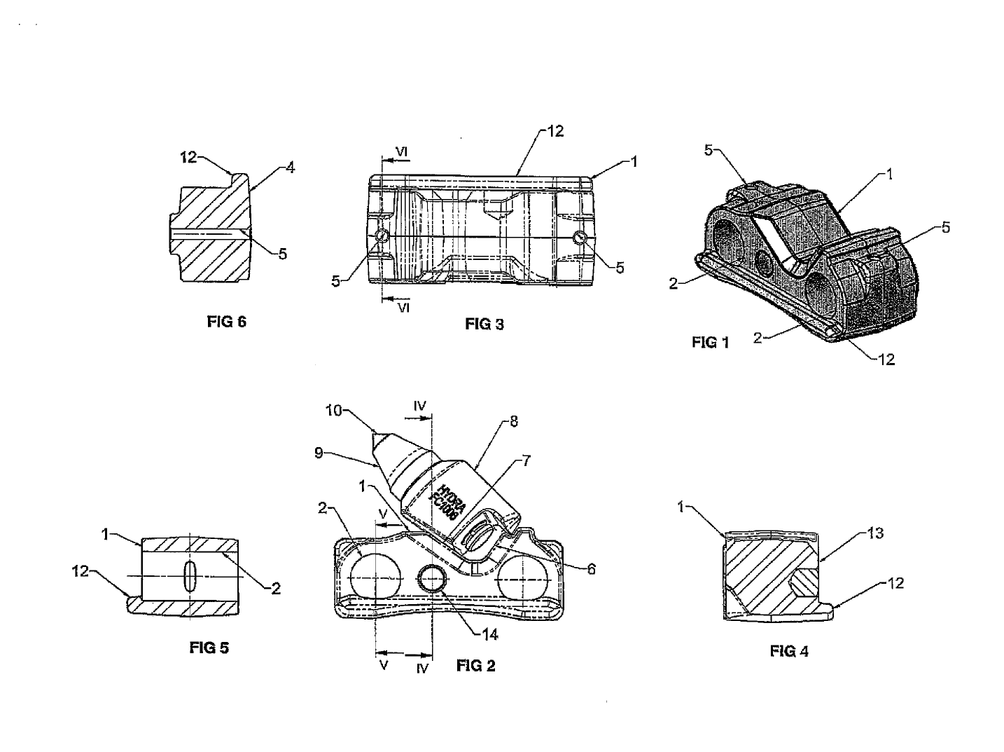

In FIGS. 1 to 6 is shown a link 1 of forged steel to form, where articulated together with a plurality of similar links or pivot pins, a cutting chain, to be described in detail later.

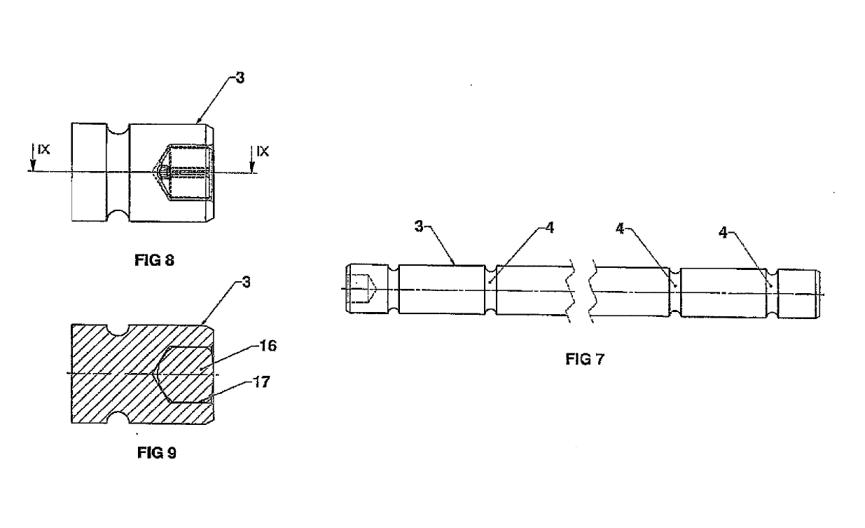

In the conventional manner, the link 1 is provided with two spaced-apart, parallel, and transversely extending through holes 2 adapted, in use, when assembled into a chain, to receive a portion of a steel pivot pin 3 (FIGS. 7 to 9 to be described in detail later), which as spaced-apart, circumferential grooves 4 to receive a knock-in, knock-out retaining pin (not shown) accommodated in holes 5 which interfere with the through holes 2, so that the retaining pins will engage a groove 4.

Also in the conventional manner, each link 1 has a seat defined by two orthogonal surfaces 6 and 7 to receive portions of a pick box 8 (also known as a tool holder) secured by welding. The pick box 8 is apertured to receive the shank of an industry-standard, point attack pick 9 provided with a carbide tip 10, a base 11 of the pick shank being exposed for engagement by an extraction tool which pick replacement is required. In addition, the wear side of the link 1 is provided, along a lower edge, with a projecting rib 12 for engagement and guidance purposes along the jib.

In accordance with the first aspect of the invention, at least one side 13 of the link 1 is provided with a wear pad 14. The latter is a tungsten carbide button, secured by suitable adhesive, in a blind hole 15 drilled into the side 13. If the link 1 is to form part of a chain for use on an inclined jib e.g. for use with an oppositely inclined second jib to cut or dig a V-shaped channel into the seabed to receive a pipeline which is subsequently buried, one side only of the link 1 will be subjected to additional wear. Hence, links 1 in accordance with the first aspect need to be located along the “wear” side of a chain, whilst conventional links may be employed for the remainder of the chain.

In accordance with the second aspect of the invention illustrated in FIGS. 7 to 9, the pivot pin 3, is also provided at one end with a button-like pad 16 of tungsten carbide, located in a blind hole 17 drilled into the “wear” end of the pivot pin 3. The other end of the pivot pin 3 is not subjected to extensive wear or abrasion, but a second wear pad 16 could also be provided at the other end.

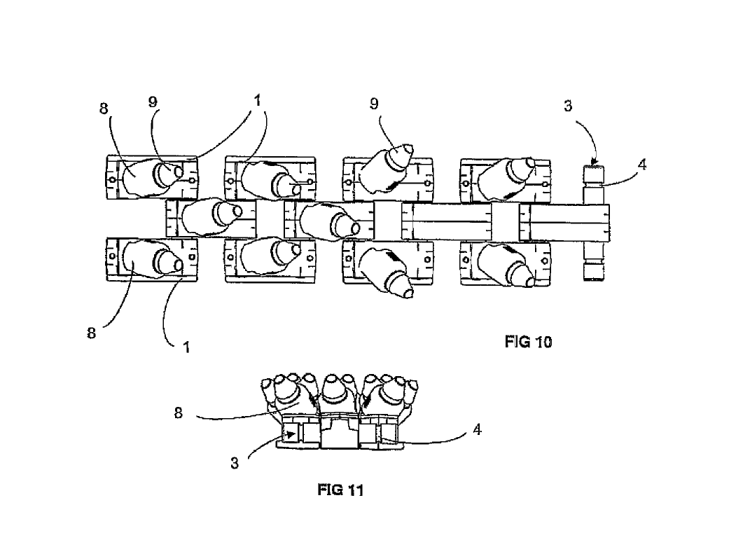

FIGS. 10 and 11 show how the links and pins of FIGS. 1 to 9 are assembled with a three-link chain, with selected links 1 provided with pick boxes 8 and others without pick boxes 8, to attain the pattern (also known as lacing) of picks required.

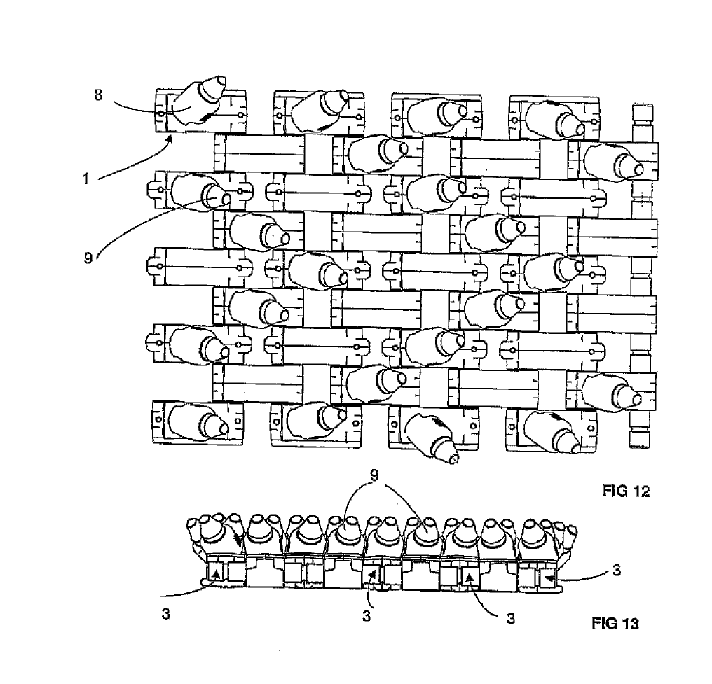

FIGS. 12 and 13 correspond to FIGS. 10 and 11, but shows a nine-link chain which is particularly suitable for use on one of a plurality of inclined jibs for seabed trenching operations, for which the links 1 of the first aspect and pins 3 of the second aspect, are particularly suitable.

1. A chain link of steel having two spaced-apart transverse apertures to receive portions of leading and trailing pivot pins and, on an upper surface, a seat to receive a welded-on pick box, characterised in that the link, at one side at least, is provided with at least one pad of a material of higher wear resistance than the steel of the link.

2. A link as claimed in claim 1, wherein a wear pad is provided only at, or in, one side of each link.

3. A link as claimed in claim 1 or claim 2, wherein intermediate the apertures for the pivot pins, a blind hole is drilled into the side of the link, to receive a wear pad.

4. A link as claimed in any preceding claim, wherein the wear pad is of solid carbide.

5. A link as claimed in claim 4, wherein the wear pad is of tungsten carbide.

6. A claim as claimed in any of claims 1 to 3, wherein the wear pad is of carbide in a matrix.

7. A link as claimed in any preceding claim, wherein the wear pad is secured in position by adhesive.

8. A link as claimed in any preceding claim, wherein along a lower edge of the link, at the wear pad side only, a projecting rib is provided.

9. A link as claimed in any preceding claim, wherein the links are heat treated steel forgings, with the wear pad glued into place after welding on of the pick box.

10. A steel pivot pin for use in connecting together, in an articulated manner, steel links of mineral cutter/removal chain, characterised in that at least one end of the pin is provided with a pad of a material of higher wear resistance than the steel of the pin.

11. A pin as claimed in claim 10, wherein a wear pad is provided at one end only of each pivot pin.

12. A pin as claimed in claim 10, wherein a wear pad is provided at each end of each pivot pin.

13. A pin as claimed in claim 10 or claim 11, wherein a blind hole is drilled into at least one end of each pivot pin into which hole(s) a wear pad is inserted.

14. A pin as claimed in any of claims 10 to 13, wherein the pivot pin wear pad is/are secured by adhesive.

15. A pin as claimed in any of claims 10 to 14, wherein the pivot pin wear pad is/are of solid carbide.

16. A pin as claimed in claim 15, wherein the pivot pin wear pad is/are of tungsten carbide.

17. A pin as claimed in any of claims 10 to 14, wherein the pivot pin wear pad is/are of carbide in a matrix.

18. A mineral cutting/removal chain for use with an inclined jib, constructed from an odd number of links as defined in any of claims 1 to 9.

19. A chain as claimed in claim 18, constructed with three, five, seven or nine links, with the outer sides of outermost links provided with at least one wear pad.

20. A mineral cutting/removal chain for use with an inclined jib, constructed from an odd number of links as defined in any one of claims 1 to 9, articulated together by a plurality of pins as defined in any of claims 10 to 17.

21. A chain as claimed in claim 20, constructed with three, five, seven or nine links, with the outer sides of outermost links provided with at least one wear pad.
